(19) United States
(12) Patent Application Publication
(10) Pub. No.: US 2012/0316884 A1
(43) Pub. Date: Dec. 13, 2012

(54) Wheelchair System Having Voice Activated Menu Navigation And Auditory Feedback

(75) Inventors: Michael Rozaieski, Springfield, KY (US); Matthias Holenweg, Buren an der Aare (CH)

(73) Assignee: Curtis Instruments, Inc.

(21) Appl. No.: 13/487,426

(22) Filed: Jun. 4, 2012

Related U.S. Application Data
(60) Provisional application No. 61/520,570, filed on Jun. 10, 2011.

(51) Int. Cl. G10L 21/00

(52) U.S. Cl. 704/275; 704/E21.001

(57) ABSTRACT

A personal mobility vehicle, such as a wheelchair system, includes an input audio transducer having an output coupled to a speech recognition system and an output audio transducer having an input coupled to a speech synthesis system. The wheelchair system further includes a control unit having a data processor and a memory. The data processor is coupled to the speech recognition system and to the speech synthesis system and is operable in response to a recognized utterance made by a user to present the user with a menu containing wheelchair system functions. The data processor is further configured in response to at least one further recognized utterance made by the user to select from the menu at least one wheelchair system function, to activate the selected function and to provide audible feedback to the user via the speech synthesis system.

### CLAIM OF PRIORITY FROM COPENDING PROVISIONAL PATENT APPLICATION

This patent application claims priority under 35 U.S.C. §119(e) from Provisional Patent Application No. 61/520,570, filed Jun. 10, 2011, the disclosure of which is incorporated by reference herein in its entirety.

### TECHNICAL FIELD

The exemplary embodiments of this invention relate generally to personal mobility vehicles such as wheelchairs, and more specifically relate to user interfaces that include one or more of audio input, speech recognition, speech synthesis and audio output systems for such vehicles.

### BACKGROUND

Self-powered personal mobility vehicles, such as wheelchairs having a self-contained power source to provide drive power to wheels and steering actuators, may include a data processor subsystem to control the various power and motive subsystems of the vehicle, as well as to implement a user interface function enabling an occupant of the vehicle to control the overall operation of the vehicle, such as to start, stop and steer the vehicle.

A problem that can arise relates to providing mobility equipment with access points for individuals with severe disabilities. These access points allow the individual to give commands to the system and thereby control a menu structure and various functions that are accessible via the wheelchair control system.

Currently systems require additional switches placed in various locations or a complex sequence of switch activations to initiate mode and or select commands. Unfortunately these access points are not always physically available to the individual, or the individual may not have the ability to reliably activate the switches. Even when reliable activation is possible the resulting control process can be slow and cumbersome.

Another limitation of current mobility systems is an inability of the control system to provide audible feedback beyond basic tones to prompt users with limited visual or cognitive ability to a location within the menu structure of the mobility system.

### SUMMARY

The foregoing and other problems are overcome, and other advantages are realized, in accordance with the presently preferred embodiments of this invention.

The exemplary embodiments of this invention provide a personal mobility vehicle, such as a wheelchair system, that comprises an input audio transducer having an output coupled to a speech recognition system and an output audio transducer having an input coupled to a speech synthesis system. The wheelchair system further includes a control unit that comprises a data processor and a memory. The data processor is coupled to the speech recognition system and to the speech synthesis system and is operable in response to a recognized utterance made by a user to present the user with a menu comprising wheelchair system functions. The data processor is further configured in response to at least one further recognized utterance made by the user to select from the menu at least one wheelchair system function, to activate the selected function and to provide audible feedback to the user via the speech synthesis system.

For example, a further aspect of the exemplary embodiments of this invention is a method to operate a wheelchair system that comprises, in response to an utterance made by a user, presenting the user with a menu comprising wheelchair system functions; and in response to at least one further utterance made by the user, selecting from the menu at least one wheelchair system function and activating the selected function.

Further by example, another non-limiting aspect of the exemplary embodiments of this invention is a memory that tangibly stores a computer program for execution by a data processor to operate a wheelchair system by performing operations that comprise receiving an output from a speech recognition system comprising a recognized utterance made by a user; presenting the user with a menu comprising wheelchair system functions; and in response to at least one further utterance made by the user, selecting from the menu at least one wheelchair system function and activating the selected function.

Further by example, another non-limiting aspect of the exemplary embodiments of this invention a method that comprises receiving at a wireless communication device an utterance that is vocalized by a user of a wheelchair system; recognizing the received utterance and converting the recognized utterance into a command; and wirelessly transmitting data that comprises the command to a wireless receiver of the wheelchair system for use by a control system of the wheelchair system.

### BRIEF DESCRIPTION OF THE DRAWINGS

The foregoing and other aspects of the presently preferred embodiments of this invention are made more evident in the following Detailed Description of the invention, when read in conjunction with the attached Drawing Figures, wherein:

FIG. 1A is an elevational view of an embodiment of a personal mobility vehicle that is suitable for implementing the exemplary embodiments of this invention.

FIG. 1B shows in greater detail a user interface/control portion of the vehicle of FIG. 1A.

FIG. 2 is a simplified block diagram of a wheelchair system controller in accordance with the exemplary embodiments of this invention.

FIG. 3 is an elevational view of one exemplary embodiment of at least a portion of the user interface.

FIGS. 4A-4E illustrate various non-limiting examples of display screen formats, menu displays and profiles.

FIG. 5 is a logic flow diagram that illustrates the operation of a method, and a result of execution of computer program instructions embodied on a computer readable medium, in accordance with the exemplary embodiments of this invention.

FIG. 6 is a logic flow diagram that illustrates the operation of a method, and a result of execution of computer program instructions embodied on a computer readable medium, further in accordance with the exemplary embodiments of this invention.

### DETAILED DESCRIPTION

In one aspect thereof the exemplary embodiments of this invention utilize voice commands to allow quick navigation to various wheelchair-based functions that would commonly be required by the user. The exemplary embodiments also provide an ability to generate enhanced audio feedback to the user in order to, for example, facilitate the navigation of control menu structures and other types of control mechanisms.

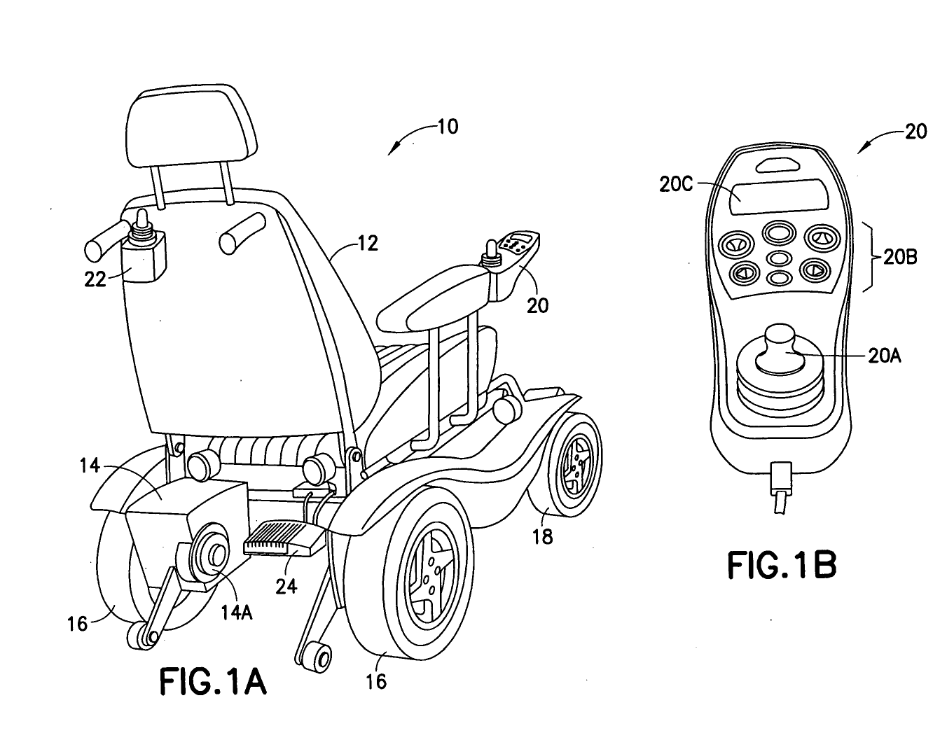

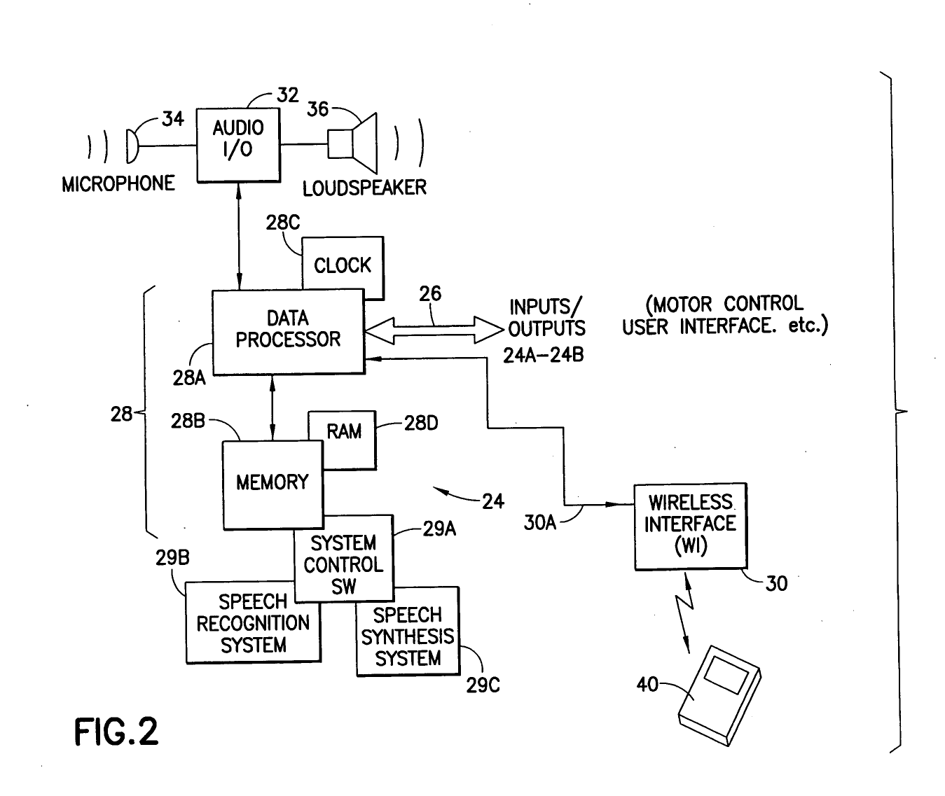

Before describing the exemplary embodiments of this invention in detail reference is first made to FIG. 1A for showing a rear elevational view of an embodiment of a personal mobility vehicle that is suitable for implementing the exemplary embodiments of this invention, as well as to FIG. 1B that shows in greater detail a user interface portion of the vehicle of FIG. 1A. In the embodiment shown in FIGS. 1A and 1B the personal mobility vehicle is embodied as a wheelchair system 10, although this is not a limitation upon the use and practice of the exemplary embodiments of this invention. As employed herein a wheelchair system is considered as a vehicle that may be capable of controlled, self-powered (e.g., battery powered) movement for a sitting person.

The wheelchair system 10 includes a seat portion 12, a power source 14, such as a battery and related power conversion, conditioning and recharging circuitry, and at least two wheels 16 that are driven by the power source 14 via at least one motor 14A. One or more other wheels 18 provide stability and enable steering of the wheelchair system 10. In this regard there is a user-actuated hand control system 20 that may include a joystick type controller 20A, a plurality of buttons 20B, and a display 20C, such as an LCD, LED or other suitable type of display system. An attendant control system 22 may also be provided. The control system 20 operates with a control system of controller 24 to provide functions that include, but need not be limited to, starting and stopping motive power to the drive wheels 16, controlling the direction of rotation and speed of rotation of the drive wheels 16, and possibly controlling a pointing direction of the wheels 18 to provide steering of the wheelchair 10 (although many wheelchair systems are steered by controlling the speed and/or direction of the two main drive wheels).

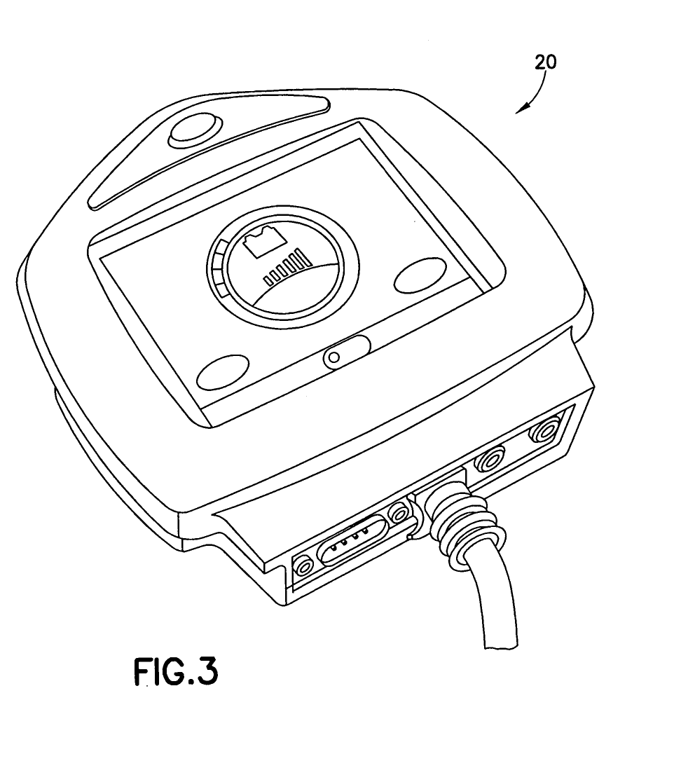

FIG. 2 shows a simplified block diagram of a portion of the controller 24. The controller 24 can be assumed to include a software system 28 that includes at least one data processor 28A, such as a microprocessor or microcontroller, and a memory 28B that stores programs to control operation of the data processor 28A and, thereby, to control the overall operation of the wheelchair 10. The operating programs, also referred to as system control software (SW) 29A, may include firmware, such as computer programs that are permanently stored in, by example, non-volatile read only memory (NV-ROM), or system control SW 29A may be stored in volatile random access memory (RAM) 28D that is loaded from a disk or some other type of memory storage medium. The exemplary embodiments of this invention are also usable with a system where the system control SW 29A is stored in a mass memory device, such as a disk, and loaded into RAM as needed.

FIG. 2 also shows an optional wireless interface (WI) 30, such as a Bluetooth™ interface, whereby a local, short range (e.g., meters or tens of meters) wireless connection can be made with a local device or devices, such as the device 40 (e.g., a cell phone or a smartphone). The wireless interface 30 could, in other embodiments, comprise a WiFi or other type of wireless interface.

In addition to the system control SW 29A, and in accordance with an aspect of this invention, there is a speech recognition system software module 29B that can be either a speaker-independent or a speaker-dependent (trained) speech recognition system. There can also be an optional speech synthesis system software module 29C. These two software modules operate in conjunction with an audio input/output (I/O) system 32 that receives an audio input from at least one audio input transducer, such as a microphone 34 (e.g., a condenser or electret or piezo-type microphone), and that provides an audio output to at least one audio output transducer, such as a loudspeaker 36 (e.g., a magnetic or an electrostatic or a piezoelectric or a horn-type speaker).

In some embodiments at least one of the microphone 34 and the loudspeaker 36 can be integrated into a headset that is wearable by a user of the wheelchair system 10, and in this case at least the microphone output can be sent to the speech recognition system software module 29B via the wireless interface 30 (e.g., via a Bluetooth™ connection). In other embodiments the microphone 34 and the speech recognition system software module 29B can be integrated into a user-wearable headset, and in this case the output of the speech recognition system software module 29B can be sent to the control system 24 via the wireless interface 30 (e.g., via a Bluetooth™ connection). In other embodiments at least one of the microphone 34 and the loudspeaker 36 can be integrated into the user-actuated hand control system 20. In general, the microphone 34 and the loudspeaker 36 can be located anywhere that is convenient for the user of the wheelchair system 10. Preferably the microphone 34 is arranged and mounted (or worn by the user) so as to provide an optimal sound pickup capability that is compatible with the needs of the speech recognition system software module 29B.

An audio input signal from the audio I/O 32 can be digitized and processed by the speech recognition system software module 29B that then outputs signals representing recognized speech and utterances. Digital data representing speech or sounds can be processed by the speech synthesis system software module 29C which then causes the audio I/O 32 to drive the loudspeaker 36 so as to reproduce the speech or sounds. In some embodiments the signals passing to and from the audio I/O 32 can be digital signals.

In some embodiments a separate dedicated processor may be used to execute the speech recognition system software module 29B. In some embodiments a separate dedicated processor may be used to execute the speech synthesis system software module 29C. Alternatively one or both of these software modules may be executed by the data processor 28A. In like manner in some embodiments the audio I/O 32 may be implemented as a stand-alone audio processing system having self-contained circuitry and a programmed data processor, such as one or more digital signal processors (DSPs), or some or all of the functionality of the audio I/O 32 may be executed by the data processor 28A.

In some embodiments the audio I/O 32 can include an audio codec, such as a computer program or algorithm that compresses/decompresses digital audio data according to a given audio file format or streaming audio format. A purpose of the audio codec algorithm is to represent a high-fidelity audio signal with a minimum number of bits while retaining the quality. This can effectively reduce the storage space and the bandwidth required for transmission of a stored audio file. In hardware an audio codec can refer to a (single) device that encodes analog audio as digital signals and decodes digital back into analog. In this case the audio codec can contain both an analog-to-digital converter (ADC) and a digital-to-analog converter (DAC) to support both audio-in and audio-out applications.

The audio I/O 32 can include at least one audio amplifier, i.e., an electronic amplifier that amplifies low-power audio signals (signals composed primarily of frequencies between 20 Hz-20,000 Hz, the human range of hearing) to a level suitable for driving loudspeakers. Power amplifier circuits (output stages) are classified as A, B, AB and C for analog designs, and class D and E for switching designs. Where efficiency is not a consideration, most small signal linear amplifiers are designed as class A. Class A amplifiers are typically more linear and less complex than other types, but are not as efficient. This type of amplifier is most commonly used in small-signal stages or for low-power applications (such as driving headphones). Class D amplifiers use switching to achieve high power efficiency (e.g., more than 90% in modern designs). By allowing each output device to be either fully on or off the losses are minimized. The analog output is created by pulse-width modulation (pwm).

It is noted that the exemplary embodiments of this invention are not limited for use with any particular one or more types of audio codecs, audio amplifiers, audio file formats (e.g., uncompressed (e.g., WAV), lossless compression (e.g., FLAC) or lossy compression (e.g., MP3)), audio file compression/decompression algorithms, microphones, loudspeakers, speech (more generally sound) recognition systems or speech (more generally sound) synthesis systems.

The data processor 28A is coupled via general use input/output hardware 26 to various input/outputs, including general input/outputs, such as input/outputs 24A going to and from the user-actuated hand control system 20 and inputs/outputs 24B providing control to the motor(s) 14. A clock function or module 28C can be included for maintaining an accurate time of day and calendar function.

An aspect of this invention is that at least some (or all) of the wheelchair 10 mobility and auxiliary functions and systems are controllable by the data processor 28A based on inputs received from the speech recognition system 29B.

The embodiments of this invention permit users with limited dexterity and/or physical ability an alternative for menu navigation and mode selection.

The integration of the voice control and auditory feedback into the wheelchair system 10 enables navigation of system control menus without the addition of external switches or complex switch sequences.

The system learns to recognize verbal commands that are mapped to certain wheelchair controlled functions such as seating and auxiliary controls. These verbal commands can be, for example, a basic word or phrase such as “Seat”, which allows the user to manipulate their seating position. The verbal commands can also take the form of atypical words or sounds or utterances that are learned by the system and associated with certain functions to allow individuals, such as those with learning, developmental or trauma-induced disabilities, to use a limited vocabulary or speech pattern to gain additional control of the wheelchair and its functions. That is, any sound that can be uttered reliably and repeatably by the user can be associated during a learning mode with a particular wheelchair function, and the uttered sound may not be word per se.

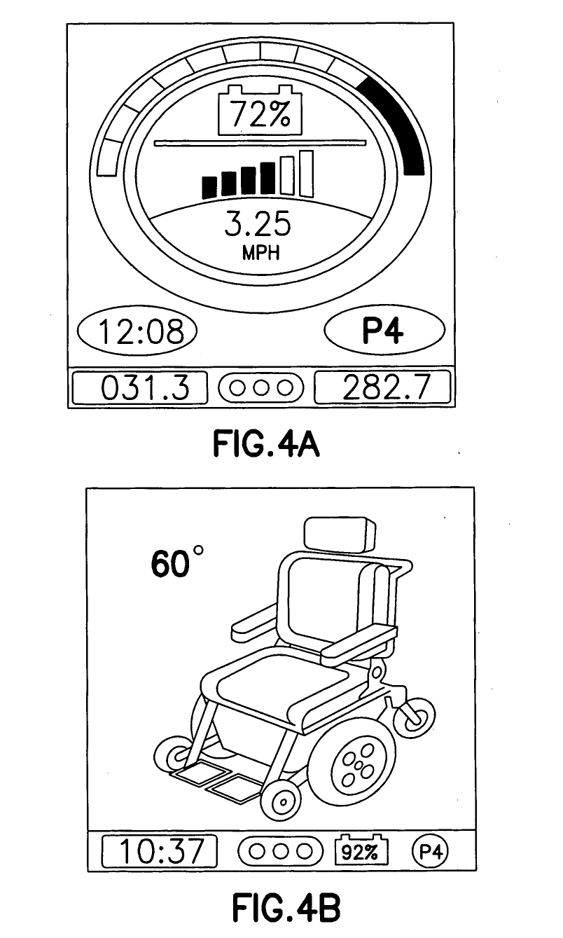

The ability to manipulate the position within a displayed menu (e.g., one displayed on the display 20C of FIGS. 1B and 3) by using voice commands, without the use of switches, enables faster and more direct access to wheelchair controlled functions.

The embodiments of this invention can also be applied to environmentally-based functions such as mouse emulation, and to wireless (e.g., infrared) control of some external device or system via the wireless interface 30.

The incorporation of the audio speaker 36 combined with voice feedback also assists those individuals with visual and cognitive impairment in controlling both on-chair and off-chair devices. The voice feedback can be used to prompt those wheelchair users that are unable to see or understand information typically displayed on an LCD screen (the display 20C) as to their location within the menu structure and prompt them to select from a menu of available commands.

The integration of these various features into, for example, the hand control 20 of the power wheelchair system 10 provides solutions not currently available to those with physical, visual and/or cognitive impairments.

In the speaker-independent speech recognition mode the user can program the word that the user will say. For those users with speech impediments this could be any sound that is otherwise not recognizable as a spoken word.

The exemplary embodiments can use a speaker-dependent voice recognition system of an external device 40, such as a cell phone or a smartphone or a tablet or another type of device, to send a command via the wireless interface 30 (e.g., Bluetooth™) to the wheelchair control system 24. For example, an application program (app) running on the external device 40 can take a recognized command and format same to send to the control system 24. In this embodiment then there can be a method that comprises receiving at a wireless communication device 40 (e.g., a cell phone) an utterance that is vocalized by a user of the wheelchair system 10; recognizing the received utterance and converting the recognized utterance into a command; and wirelessly transmitting data that comprises the command to a wireless receiver 30 of the wheelchair system 10 for use by the control system 28A, 29A of the wheelchair system.

The exemplary embodiments can also use a speaker-dependent or independent speech recognition system integrated into the wheelchair system (the recognition system 29B) to provide the commands directly to the control system 24 and to also (optionally) send commands to a phone 40 via the wireless interface 30.

The exemplary embodiments can also use a third device, such as a Bluetooth™ earpiece that has an integrated speaker-independent or a speaker-dependent speech recognition system, to send commands to the appropriate device (wheelchair or phone) via Bluetooth™ where applicable.

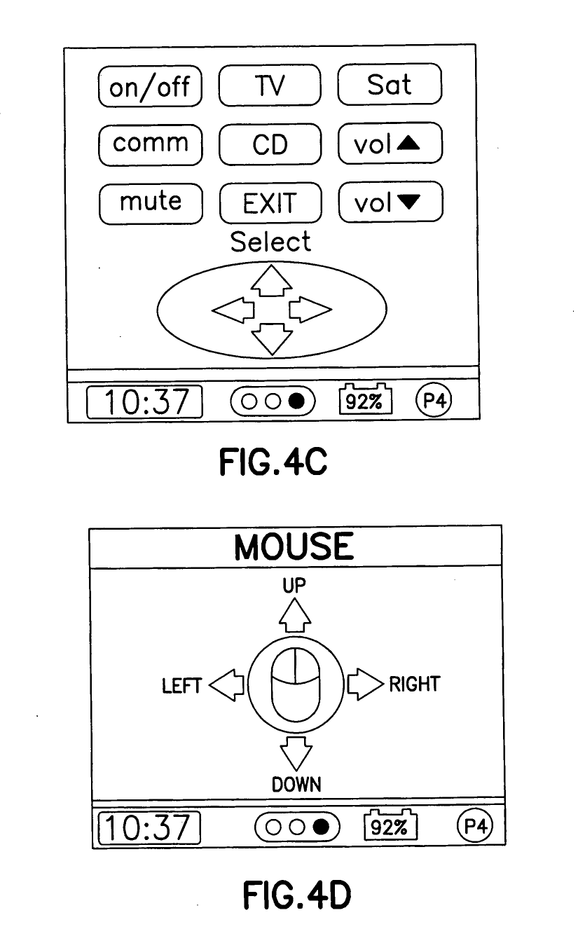

Reference can be made to FIGS. 4A-4E for illustrating various non-limiting examples of display screen 20C display formats, menus and profiles.

### Drive Screen: (FIG. 4A)

The drive screen is displayed (e.g., see also FIG. 3) when the wheelchair 10 is prepared to be driven. As indicated in FIG. 4A the wheelchair is currently in Profile 4 “P4”. The profiles typically indicate different speeds or performance characteristics such as indoor or outdoor. It is intended that these different profiles will be accessed by the user stating some command such as “Profile 3”, or “Indoor”, or “Home”, or “Fast”, etc. Once the command is received and confirmed the wheelchair 10 will automatically navigate the menu to the specified profile and prepare to receive further commands from the user via the input device, typically the joystick 20A, or to receive a further command via the speech recognition system 29B.

### Seat Screen: (FIG. 4B)

The seat screen allows the user to manipulate his seated position electro-mechanically for comfort, circulation, pressure reduction, respiration and other purposes. This screen highlights a portion of the image (shown in FIG. 4B as the lighter colored seat area designated ‘H’), and the function that can be controlled by the wheelchairs drive input device, usually the joystick 20A. In the image a Recline function (60°) is currently active.

The wheelchair 10 typically includes multiple actuators that are available for access by the user such as Tilt, Power Leg Rests, Power Seat Elevator etc. It is intended that a voice command such as “Seat”, once confirmed, will cause the image of the wheelchair seating system to be displayed. Other commands such as “Tilt” or “Legs” when spoken and recognized then automatically ready the wheelchair 10 for activation of the specified seat position movement. The commands can be extended for even further functionality such as “Recline Back 40 Degrees”, which when spoken and recognized causes the wheelchair backrest to recline 40° relative to the wheelchair base

A number of Auxiliary Functions can also be controlled. Several non-limiting examples are as follows.

### TV Function: (FIG. 4C)

A number of consumer devices can be programmed to operate through the wheelchair's input system via infrared and Bluetooth wireless communication. FIG. 4C shows a typical television set-up. The shown graphical user interface (GUI) references a number of common commands/control functions that are used with a television. The wheelchair user can say “TV” and the control system automatically navigates directly to the menu displayed in FIG. 4C. As the commands in these Auxiliary menus are typically not safety critical the user can simply say “TV Volume Up” and have the wheelchair send the appropriate wireless command to increase the volume of the selected television set. This embodiment thus implements a voice-controlled television (more generally consumer media device) remote control function.

### Mouse Emulation: (FIG. 4D)

Computer mouse emulation can also be controlled by the wheelchair input device. The user can speak the word “Mouse” and the system will navigate directly to the Mouse menu displayed in FIG. 4D. Once the Mouse menu is displayed, as shown, the wheelchair user can speak typical commands such as “Left Click”, “Right Click”, “Double left Click”, “Scroll” in order to emulate the full feature set of a typical mouse input. By the use of the wireless interface (IR or Bluetooth™) the user can operate a PC or tablet computer with the user's voice commands controlling the mouse functions.

### Menu Navigation: (FIG. 4E)

For those situations where direct navigation is not possible the user can employ a series of commands to navigate through a hierarchical menu structure. The menu screen can be accessed by simply saying “Menu”. The user can then use basic voice commands such as “Up”, “Down”, “Left”, “Right” and “Select” to allow full control of all wheelchair functions including the auxiliary functions. This mode of operation enables the user to navigate the menu without having to learn and remember a large number of specific commands.

As was noted above, the various commands can be predefined or they can be customized for or by the user. This can be particularly beneficial for those users with speech impairments who are unable to form or clearly speak specific commands.

It should thus be appreciated that the use of the exemplary embodiments of this invention provides a number of advantages, features and technical effects.

As one example, the audio output can be used to emulate a horn (warning sound), where the acoustic level of the horn can be adjusted as well as the tone and sound pattern. In addition, customizable sounds can be used (e.g., ringtone, files to be played).

Media files can be downloaded, such as through the wireless interface 30, and stored in the memory 2813 for playback as needed using the speech (sound) synthesis system 29C.

Further, the invention enables the wheelchair system 10 to make audible an audio stream from an external device, such as a mobile phone or a media player. This connection may be made via the wireless interface 30.

Further, the invention enables the wheelchair system 10 to synthesize speech upon user request, such as “I'm hungry”. The system can also provide audible (speech) feedback, such as “Drive 2”, or “Battery Low”.

Further, the invention enables the wheelchair system 10 to provide, via the speech synthesis system 29C and in conjunction with the clock 28C, a pre-recorded audio reminder, to the user such as, for example, “It is now time to take your evening medication”.

Further, the invention enables the wheelchair system 10 to provide via the speech synthesis system 29C service-related data transport via an audio channel over a phone and a telecommunications network for remote service applications. For example, system diagnostic and maintenance-related data files, warnings and recommendations can be converted to an audio (speech) signal and sent over the wireless interface 30 to a remote maintenance location, possibly via a local smartphone or PC (e.g., using voice over Internet protocol (VoIP)). Service-related feedback and/or recommendations and/or instructions can also be received via the wireless interface 30 and enunciated to the user (or to an attendant in proximity to the wheelchair) via the speech synthesis system 29C in a similar manner (e.g., via the wireless interface 30).

Further, the invention enables the wheelchair system 10 to record user speech (or speech of an attendant person).

Further, and as was discussed above, the invention enables the wheelchair system 10 to recognize the user's speech and to perform certain pre-defined actions related to the speech message/command.

It should be appreciated that the use of this invention enables some or all of the functionality of the user-actuated hand control system 20 (e.g., the visual display 20C and/or the joystick type controller 20A) to be supplemented by, or replaced entirely by, the functionality of the audio I/O 32, microphone 34, speaker 36, speech recognition system 29B and speech synthesis system 29C, in cooperation with the data processor 28A and system control software 28D. That is, the exemplary embodiments provide an ability to totally control the operation of the wheelchair system 10 by the user (or an attendant), including the speed and direction, via the functionality of the audio I/O 32, microphone 34, speaker 36, speech recognition system 29B and speech synthesis system 29C.

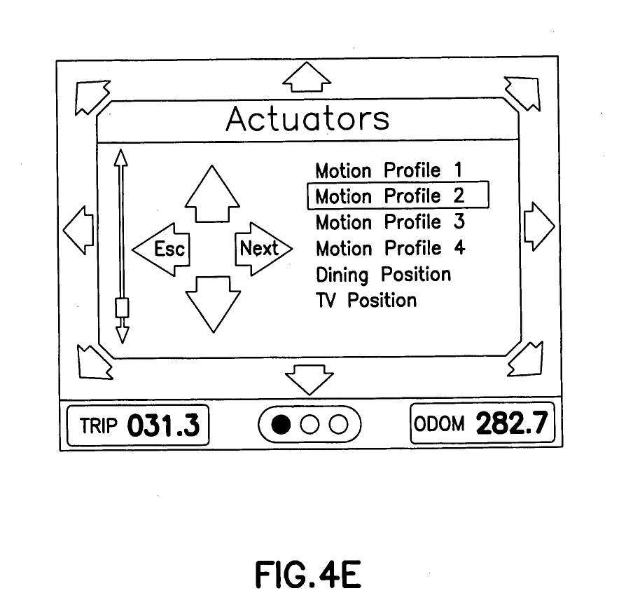

FIG. 5 is a logic flow diagram that illustrates the operation of a method, and a result of execution of computer program instructions embodied on a computer readable medium, in accordance with the exemplary embodiments of this invention. At Block 5A there is a step performed, in response to an utterance made by a user, of presenting the user with a menu comprising wheelchair system functions. At Block 5B there is a step performed, in response to at least one further utterance made by the user, of selecting from the menu at least one wheelchair system function and activating the selected function.

In the method as depicted in FIG. 5, where the steps of presenting and selecting are performed in accordance with an output from a speech recognition system that receives the utterances of the user.

In the method as depicted in FIG. 5, where the wheelchair functions are functions related to mobility of the wheelchair system.

In the method as depicted in FIG. 5, where the wheelchair functions are functions related to a seat of the wheelchair system.

In the method as depicted in FIG. 5, where the wheelchair functions are functions related to auxiliary functions of the wheelchair system, such as auxiliary functions that comprise in part an ability to control via a wireless interface at least one device that is external to the wheelchair system.

In the method as in the preceding paragraph, where the at least one device is controlled based on an utterance made by the user, where the utterance is converted to an appropriate command for the at least one device and the command is transmitted over the wireless interface.

In the method as depicted in FIG. 5, where the wheelchair functions are presented in a menu to the user, and further comprising navigating the menu and selecting a function from the menu based on at least one further utterance of the user.

In the method as depicted in FIG. 5 and in any one of the preceding paragraphs descriptive of FIG. 5, and further comprising a step of generating audible feedback to the user.

In the method as depicted in FIG. 5 and discussed in the preceding paragraph, where the step of generating audible feedback comprises operating a speech synthesis system.

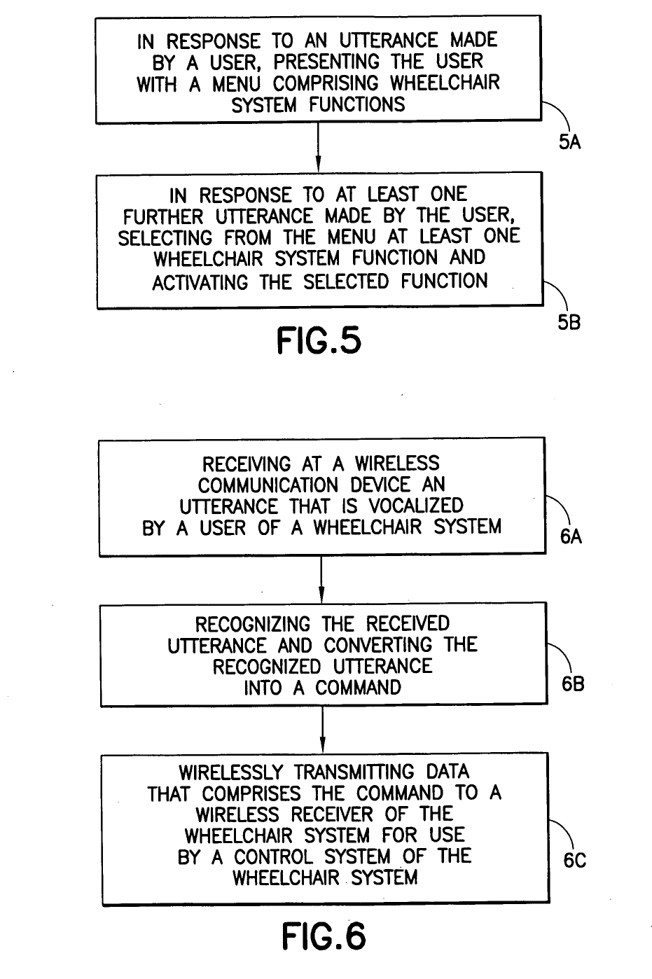

FIG. 6 is a logic flow diagram that illustrates the operation of a method, and a result of execution of computer program instructions embodied on a computer readable medium, further in accordance with the exemplary embodiments of this invention. At Block 6A there is a step performed of receiving at a wireless communication device an utterance that is vocalized by a user of a wheelchair system. At Block 6B there is a step of recognizing the received utterance and converting the recognized utterance into a command. At Block 6C there is a step of wirelessly transmitting data that comprises the command to a wireless receiver of the wheelchair system for use by a control system of the wheelchair system.

The step of wirelessly transmitting can use a low power radio transmission.

Various modifications and adaptations of the foregoing exemplary embodiments of this invention may become apparent to those skilled in the relevant arts in view of the foregoing description, when read in conjunction with the accompanying drawings and the appended claims. As but some examples, the use of the exemplary embodiments of this invention is not limited to wheelchairs, but could encompass other types of mobility systems.

Further, the user interface of the wheelchair system 10 may be implemented at least in part using any suitable biometric means compatible with the physical capabilities of the user, and are not limited to the visual and/auditory means discussed above. Some examples of biometric means can include a manually-operated interface or an eye or a gaze tracking interface or an interface that responds to electrical signals generated by or from the user, such as signals obtained from nervous system activity, as non-limiting examples.

All such and similar modifications of the teachings of this invention will still fall within the scope of the embodiments of this invention.

Furthermore, some of the features of the preferred embodiments of this invention may be used to advantage without the corresponding use of other features. As such, the foregoing description should be considered as merely illustrative of the principles, teachings and embodiments of this invention, and not in limitation thereof.

What is claimed is:

1. A method to operate a wheelchair system, comprising:
in response to an utterance made by a user, presenting the user with a menu comprising wheelchair system functions; and
in response to at least one further utterance made by the user, selecting from the menu at least one wheelchair system function and activating the selected function.

2. The method of claim 1, where presenting and selecting are performed in accordance with an output from a speech recognition system that receives the utterances of the user.

3. The method of claim 1, where the wheelchair functions are functions related to mobility of the wheelchair system.

4. The method of claim 1, where the wheelchair functions are functions related to a seat of the wheelchair system.

5. The method of claim 1, where the wheelchair functions are functions related to auxiliary functions of the wheelchair system.

6. The method of claim 5, where the auxiliary functions comprise in part an ability to control via a wireless interface at least one device that is external to the wheelchair system.

7. The method of claim 6, where the at least one device is controlled based on an utterance made by the user, where the utterance is converted to an appropriate command for the at least one device and the command is transmitted over the wireless interface.

8. The method of claim 1, where the wheelchair functions are presented in a menu to the user, and further comprising navigating the menu and selecting a function from the menu based on at least one further utterance of the user.

9. The method as in claim 1, further comprising generating audible feedback to the user.

10. The method of claim 9, where generating audible feedback comprises operating a speech synthesis system.

11. A wheelchair system, comprising:
an input audio transducer having an output coupled to a speech recognition system;
an output audio transducer having an input coupled to a speech synthesis system;
a control unit that comprises a data processor and a memory, said data processor being coupled to the speech recognition system and to the speech synthesis system and operable in response to a recognized utterance made by a user to present the user with a menu comprising wheelchair system functions, said data processor being further configured in response to at least one further recognized utterance made by the user to select from the menu at least one wheelchair system function, to activate the selected function and to provide audible feedback to the user via the speech synthesis system.

12. The wheelchair system of claim 11, where the wheelchair functions are functions related to mobility of the wheelchair system.

13. The wheelchair system of claim 11, where the wheelchair functions are functions related to a seat of the wheelchair system and provide an ability at least to change an inclination of the seat relative to a base of the wheelchair system.

14. The wheelchair system of claim 11, where the wheelchair functions are functions related to auxiliary functions of the wheelchair system.

15. The wheelchair system of claim 14, further comprising a wireless interface, and where the auxiliary functions comprise in part an ability to control via the wireless interface at least one device that is external to the wheelchair system.

16. The wheelchair system of claim 15, where the at least one device is controlled based on an utterance made by the user, where the utterance is converted in cooperation with the speech recognition function to an appropriate command for the at least one device and the command is transmitted over the wireless interface.

17. The wheelchair system of claim 15, where said wireless interface is comprised of a low power radio interface or an infrared interface.

18. The wheelchair system of claim 11, where the wheelchair functions are presented in a menu to the user on a display of the wheelchair system, and further comprising navigating the menu and selecting a function from the menu based on at least one further utterance of the user.

19. The wheelchair system of claim 11, where said input and output audio transducers are embodied in one of a user-actuated mobility control system of the wheelchair system or a headset worn by the user.

20. A memory that tangibly stores a computer program for execution by a data processor to operate a wheelchair system by performing operations that comprise:
receiving an output from a speech recognition system comprising a recognized utterance made by a user;
presenting the user with a menu comprising wheelchair system functions; and
in response to at least one further utterance made by the user, selecting from the menu at least one wheelchair system function and activating the selected function.

21. The memory of claim 20, where the wheelchair functions are functions related to mobility of the wheelchair system, a seat of the wheelchair system and auxiliary functions of the wheelchair system.

22. The memory as in claim 20, further comprising generating audible feedback to the user by operating a speech synthesis system.

23. A method comprising:
receiving at a wireless communication device an utterance that is vocalized by a user of a wheelchair system;
recognizing the received utterance and converting the recognized utterance into a command; and
wirelessly transmitting data that comprises the command to a wireless receiver of the wheelchair system for use by a control system of the wheelchair system.

24. The method as in claim 23, where wirelessly transmitting uses a low power radio transmission.
